(19) United States
(12) Patent Application Publication
(10) Pub. No.: US 2015/0250206 A1
(43) Pub. Date: Sep. 10, 2015

(54) METHODS OF FEEDING AND MAKING ANIMAL FEED ADAPTED TO DETER WILD BIRD CONSUMPTION AND PRODUCTS THEREOF

(71) Applicant: PURINA ANIMAL NUTRITION LLC, Shoreview, MN (US)

(72) Inventors: Catherine M. Klein, Valley Park, MO (US); Jill A. Davidson, Washington, MO (US)

(73) Assignee: PURINA ANIMAL NUTRITION LLC, Shoreview, MN (US)

(21) Appl. No.: 14/201,389

(22) Filed: Mar. 7, 2014

(51) Int. Cl. A23K 1/00; A23K 1/14; A23K 1/18

(52) U.S. Cl. CPC A23K 1/005; A23K 1/1813; A23K 1/14

(57) ABSTRACT

Methods of deterring wild bird consumption of feeds containing nutrients susceptible to wild bird consumption, methods of producing a feed material adapted for deterring wild bird consumption, and a feed product with a composition adapted for deterring wild bird consumption are provided by inclusion of fats in the animal feed that contain high levels of saturated fats. Saturated fats may be derived from hydrogenated vegetable oil and other fat sources in which a large portion of the saturated fat is formed of stearic acid or stearic acid in combination with palmitic acid.

### TECHNICAL FIELD

The present disclosure provides feeding systems for deterring wild bird consumption of animal feed products, methods of forming these animal feed products and the animal feed products themselves.

### BACKGROUND

In 2012, USDA Animal and Plant Health Inspection Service (APHIS) investigators reported commercial dairies in Pennsylvania, New York and Wisconsin suffered from feed loss and bird fecal contamination throughout the year, but at a higher extent during the first quarter of the year. European starlings are the most destructive species, but other wild birds are also to blame for these problems. Dairies reporting no bird problems, such as those that take affirmative measures to deter wild birds, spent $4.92 on feed cost per hundredweight of milk. In contrast, dairies reporting bird populations greater than 10,000 spent $2.07 more on feed cost per hundredweight. For example, a starling weighing 85 grams can eat about 2 pounds of feed per month. Where ruminant feed cost of 13 cents per pound of dry matter, this equates to 26 cents per bird per month. When producers manage large facilities, thousands of birds may scavenge animal feed resulting in tens of thousands of dollars of lost feed per year.

It is believed that wild birds prefer energy-dense ingredients, particularly starch, in feedlot and dairy rations. Starch feed ingredients, however, come at a higher cost, and when birds sort feed, starch loss will be incurred, which alters the composition of the animal's diet, which can reduce animal performance such as meat and milk production.

Bird-control strategies differ in terms of their cost and effectiveness. For example, feed treated with methyl anthranilate has been found to deter wild birds from consuming these feeds. However, cost concerns with this additive have resulted in a search for alternative methods to deterring wild bird consumption of animal feed.

### SUMMARY

The present disclosure provides methods of deterring wild bird consumption of feeds containing nutrients susceptible to wild bird consumption, methods of producing a feed material adapted for deterring wild bird consumption, and a feed product with a composition adapted for deterring wild bird consumption. Feeds that are otherwise susceptible to wild bird consumption generally include non-avian animal feeds including, but not limited to, feeds for livestock animals, zoo animals, and companion animals. Each of these animal feeds may include nutrients susceptible to wild bird consumption such as starches including sugars, protein and some fats. In particular, it has been discovered that by including fats with high levels of saturated fat, such as at least 80 percent saturated fat by weight of the fat, results in a product that is less palatable or not palatable to wild birds, which enables the feed to be available to the animal for which it is intended, thus saving on animal feed costs and resulting in a more predictable nutrient intake by the animals.

According to one implementation, a method of deterring wild bird consumption of animal feed involves providing animals with a daily feed ration of an animal feed in a location accessible to wild birds, where a portion of a nutrient profile of the animal feed is susceptible to wild bird consumption. The animal feed additionally includes fat in the form of hydrogenated vegetable oil containing saturated fatty acids, and these saturated fatty acids are provided in an amount effective to reduce the wild bird consumption of the animal feed.

In another implementation, a method of forming a feed material adapted for deterring wild birds from consuming feed material otherwise susceptible to consumption by the wild birds involves forming a feed material including hydrogenated vegetable oil and at least one additional feed component susceptible to wild bird consumption. In this implementation, the hydrogenated vegetable oil is provided in an amount effective to reduce consumption of the feed material.

In yet another implementation, an animal feed is provided that includes hydrogenated vegetable oil providing at least about 20 percent of the animal feed by weight, where the hydrogenated vegetable oil contains at least about 95 percent by weight saturated fatty acids.

### BRIEF DESCRIPTION OF THE DRAWINGS

FIGS. 1 and 2 illustrate wild bird consumption of animal feed products formulated according to implementations of the present disclosure.

### DETAILED DESCRIPTION

Overview

Methods of deterring wild bird consumption of animal feed otherwise susceptible to wild bird consumption involve incorporating fats into the animal feed that contain saturated fatty acids. Feeds that are otherwise susceptible to wild bird consumption generally include non-avian animal feeds including, but not limited to, feeds for livestock animals, zoo animals, and companion animals. Livestock animals may include ruminants and pigs of any age. Zoo animals may include zebras, camelids, primates, kangaroos, bear, deer, reindeer, elk, elephants, exotic felines, exotic canines. Companion animals may include dogs, cats, rabbits and horses. These animal feeds generally include nutrients susceptible to wild bird consumption, especially starch. Other nutrients generally attractive to the wild birds also include sugars and some fats.

Saturated fatty acids are produced from the hydrogenation of fatty acids. Saturated fatty acids are those where the carbon atoms of the triglycerides are bonded to two hydrogen atoms and thus do not contain double bonds. Fully saturated fats are provided when the chain of carbon atoms in the triglyceride is fully saturated with hydrogen atoms. With increased saturation of the oil or fat, the oil or fat exhibits an increased melting point and viscosity. Generally, the saturated fatty acids of the present disclosure are solid or semi-solid state at ambient temperatures. C3:0-C36:0 saturated fatty acids may be used in connection with the animal feeds of the present disclosure. Depending on the number of carbon atoms, saturated fatty acids may be characterized as short-chain (less than 6 carbon atoms), medium-chain (from 6 to 12 carbon atoms), long-chain (from 13-21 carbon atoms), and very long-chain (greater than 22 carbon atoms). Some preferred saturated fatty acids include medium- and long-chain fatty acids such as lauric acid (C12:0), myristic acid (C14:0), pentadecanoic acid (C15:0), palmitic acid (C16:0), heptadecanoic acid (C17:0), stearic acid (C18:0), nonadecanoic acid (C19:0), and eicosanoic acid (C20:0). In more preferred embodiments, stearic acid may provide a major portion of the fat or saturated fat content in the animal feed products. For example, stearic acid may provide from about 50 to about 70, about 60 to about 70, about 62 to about 67, or about 65 percent of the fat by weight or of the saturated fat by weight. In yet another preferred embodiment, stearic acid and palmitic acid may provide a major portion of the fat content in the animal feed products, where stearic acid is provided at the levels described and palmitic acid may provide from about 10 to about 25, about 15 to about 22, or about 20 percent of the fat by weight. Such fatty acids may be present in hydrogenated vegetable oil in the aforementioned parenthetical amounts.

Saturated fatty acids may be contained in a variety of fat types including hydrogenated vegetable oil, which is a plant-based oil derived from peanut oil, safflower oil, sunflower oil, cottonseed oil, corn oil, canola oil and combinations thereof; and animal-based fats such as suet and tallow. The level of saturated fatty acids within these fat types may vary from about 1 percent by weight of the fat to about 100 percent by weight of the fat. According to certain implementations, fats containing from about 80 to about 100 percent saturated fatty acids by weight may be incorporated into the animal feed to effectively deter wild bird consumption. In more particular implementations, fats containing about 75 to about 95 percent saturated fatty acids by weight may be incorporated into the animal feed to effectively deter wild bird consumption. Even more particularly, fats containing about 85 percent saturated fatty acids by weight may effectively deter wild bird consumption when used on or within an animal feed.

Animal Feed Compositions Containing Saturated Fat

Animal feed compositions of the present disclosure contain nutrients including fat, at least a portion of which contains saturated fatty acids, as well as starch and protein. In addition, the animal feed compositions may include additives described below.

Fat contained in the animal feed includes fats with a high level of saturated fatty acids such as hydrogenated vegetable oil. Other fats may additionally be incorporated into the animal feeds of the present disclosure. For example, beef tallow, fish oil and other animal oils or fats, soybeans, soybean oil, corn, corn oil, palm oil, palm stearin, coco butter, other vegetable oils or fats and combinations thereof. These exemplary fat sources may include blends of saturated, unsaturated and polyunsaturated fats. Waxes may also be used.

The amount of fat in the animal feed may be about 20 to about 60 percent by weight of the feed, about 45 to 55 percent by weight of the feed, about 50 to about 55 percent by weight of the feed, about 50 percent by weight of the feed, or about 55 percent by weight of the feed.

Saturated fat may account for between 20 and 100 percent of the total fat, about 20 to 60 percent of the total fat, about 50 percent of the total fat, about 50 to 100 percent of the total fat, about 85 to 100 percent of the total fat, about 85 percent of the total fat, or about 100 percent of the total fat.

Fats containing a high saturated fat content may be those with 75-100 g saturated fat/100 g total fat; 80-100 g saturated fat/100 g total fat; 80-90 g saturated fat/100 g total fat, 85-95 g saturated fat/100 g total fat, or 95 g saturated fat/100 g total fat.

With respect to the animal feed itself, saturated fat, such as highly saturated fats, may account for between about 10 and 55 percent of the animal feed by weight, between about 10 and 30 percent of the animal feed by weight, between about 20 and 25 percent of the animal feed by weight.

In addition, hydrogenated vegetable oil with a high saturated fat content, as described, may account for between about 10 and 55 percent of the animal feed by weight, between about 10 and 30 percent of the animal feed by weight, or between about 20 and 25 percent of the animal feed by weight.

In one preferred implementation, a source of saturated fat, such as hydrogenated vegetable oil, may contain about 95 g saturated fat/100 g total fat by weight, and the source of saturated fat may account for about 85-100 percent of the fat in the animal feed by weight. In this implementation, for an animal feed containing about 55 percent fat by weight of the feed, saturated fatty acids may account for about 44.4 to about 52.25 percent of the feed by weight.

In another preferred implementation, a source of saturated fat, such as hydrogenated vegetable oil, may contain about 95 g saturated fat/100 g total fat by weight and the source of saturated fat may account for between about 10 and 30 percent of the animal feed by weight. In this implementation, saturated fat may account for 9.5 to about 28.5 percent of the animal feed by weight.

Because the animal feeds of the present disclosure may contain fat sources in addition to saturated fats, a balance of the fat content may be provided in the form of other fats, such as monounsaturated and polyunsaturated fats. For example, sources of unsaturated fats may be derived from corn and soy beans present in the animal feed. As described, other sources of alternative fats may include beef tallow, fish oil and other animal fats, soybean oil, corn oil, palm oil, palm stearin, coco butter, other vegetable oils or fats, and combinations thereof.

The highly saturated fats of the present disclosure may be obtained from naturally occurring fats and oils, may be derived through isolating saturated fats from fat sources containing blends of saturated fat with other fats, e.g., polyunsaturated fat and/or monounsaturated fats, may be derived through the process of hydrogenation, or combinations of these. In fractionation, saturated fats may be substantially isolated from other fats by, for example, heating a solid or semi-solid fat source containing saturated fat to a temperature where the saturated fat remains solid and other fat or fats reach a melting point at which point the melted fats may be separated from the solid fat containing the saturated fat. In addition or alternatively, a fat source may be processed in order to hydrogenate the fatty acids contained therein. Generally, hydrogenation involves sparging the oil or fat with a source of hydrogen and a catalyst (e.g., a nickel compound) at elevated temperatures and pressures. During this process, carbon-carbon double bonds are chemically reduced to a single bond such that each carbon atom forms a bond with two hydrogen atoms, thereby resulting in hydrogenation and thus saturation of the fatty acids. With increased saturation of the fatty acids, the oil or fat is characterized as highly saturated and may be fully saturated. It has been discovered that fats containing high levels of saturated fat when incorporated into animal feed deters wild birds from consuming the animal feed containing nutrients (e.g., starch (including sugar), protein, and other fats) otherwise susceptible to consumption.

Starch in the animals feeds may be derived from a variety of sources and such as corn, wheat, barley, oats, sorghum, tapioca, isolated dry or wet milled starch, their milled components and combinations of these, and any of these starch components may be susceptible to wild bird consumption. The amount of starch may account for at least about 20 percent by weight the feed, between about 20 percent by weight and about 30 percent by weight of the feed, or greater than 30 percent by weight of the feed.

Protein in the animal feed may be sourced from soybean meal, cottonseed meal and corn gluten meal. Other proteinaceous sources include other oil seed meals such as palm meal; animal by-product meals such as meat meal, poultry meal, blood meal, feather meal and fishmeal; plant by-product meals such as wheat middlings, soybean hulls and corn by-products; and microbial protein such as torula yeast and brewer's yeast. Any of the protein sources may be susceptible to wild bird consumption. The amount of protein in the animal feed may be between about 1 percent by weight and about 30 percent by weight of the animal feed, and more particularly may be about 10 percent by weight.

Additives can include, for example, amino acids, vitamins, minerals, nutraceuticals, pharmaceuticals, flavorings such as molasses, and various processing aids such as talc and calcium carbonate. According to certain implementations, the animal feeds of the present disclosure may be free of methyl anthranilate.

Methods of Producing the Animal Feed Compositions Containing Saturated Fat

Animal feeds of the present disclosure may be provided in particle (e.g., nugget or pellet) form and may be produced through extrusion or pelleting processes. For example, nutritional components and additives may be mixed and forced by a spinning screw through a restricted orifice in an extrusion process where the mixture may be subjected to high temperatures and pressures. An extruded ribbon exiting the extruder may expand and be sliced into particles. Exemplary methods of extruding animal feeds are disclosed in a co-pending U.S. application entitled “High Fat Feed Particles,” having application Ser. No. 12/822,376 and filed on Jun. 24, 2010, the contents of which are herein incorporated by reference in their entirety for any useful purpose.

In another example, nutritional components and additives may be formed into a meal and fed into a pellet mill where the meal is compressed through the holes defined by the die. During this compression, the meal is heated due to friction and the added mechanical energy. The compressed meal exits the die in a ribbon that may be sliced transversely to form particles.

In some implementations, all or a portion of the saturated fat may be reserved for use in coating and/or impregnating the particles. For example, a vacuum coater may coat and impregnate the pellets with one or more of the highly saturated fats of the present disclosure, such as hydrogenated vegetable oil. In another example, the saturated fat may be sprayed over the exterior surface of the pellets.

Methods of Feeding Animal Feed while Deterring Wild Bird Consumption of Same

Feeding methods for deterring wild bird consumption of animal feed involves providing an animal feed formulated for the target animal, e.g., targeted for non-avian animals such as ruminants, sows or horses, and replacing at least a portion of the fat content with highly saturated fat, such as hydrogenated vegetable oil or another fat in which a large portion of the saturated fat is formed of stearic acid or stearic acid in combination with palmitic acid. The animal feed may be formulated for a total mixed ration additionally including forage (e.g., grass, hay, silage) and grains (e.g. corn and/or soy beans), for example.

The animal feeds of the present disclosure may be offered in a typical manner, such as in feeding troughs or pans that are placed in environments accessible to wild birds, such as in barns, in a feed lot, in a ranch and so on. Due to the fat profile of the animal feeds of the present disclosure, wild birds are deterred from consuming the feed. In some cases, wild bird consumption is reduced by about 80 percent or more. Reduction of scavenged animal feed results in cost savings and a more predictable nutrient intake by the target animal. This can facilitate nutritionists in more accurately formulating feed rations that include the animal feed of the present disclosure, which may improve animal performance. Further, because the animal feeds of the present disclosure can be formulated according to the dietary needs of the target animal, and only modifications to the fat profile are made, the target animal readily ingests the animal feed. In some implementations, the modifications to the fat profile are made only in connection with a fat coating provided on the animal feed.

Four studies were conducted to evaluate the effectiveness of deterring ingestion of animal feed by wild birds by offering the wild birds ruminant feed having saturated fatty acids and other animal feed components, however, these studies should not be construed as limiting.

Adaptation Phase of Studies 1-4

Four pans were each filled with 5 pounds of a control animal feed nugget and were placed outside of a barn where ruminants are typically fed the animal feed nuggets as part of their total mixed ration. The control nuggets included protein, starch and fat sources, where the fat content formed about 50 percent of the animal feed nugget by weight, and saturated fat formed about 50 percent of the fat (e.g., where saturated fat about 25 percent of the weight of the nugget). The saturated fat contained approximately 19 percent stearic acid and approximately 27 percent palmitic acid. In particular, the control nuggets contained grain products (e.g., corn, wheat, cottonseed), plant protein products (e.g., soybean, soybean meal), calcium carbonate, and tallow and palm stearin as the fat sources. The location where the pans were placed was a location wild birds were known to have previously consumed test products. The treatment testing pans were each refilled each day and placed in substantially the same place outside of the barn. Consumption was measured daily until the control nuggets were being consistently consumed an average of 3.6 pounds per pan per day. Once the birds were adapted to eating from the test pans, the studies began.

Study 1

Materials and Methods:

The first study was a side-by-side comparison over the course of 5 days with 4 treatments. Treatment 1 used the control nugget with 50 percent fat derived from tallow and palm stearin (control nugget) with {50} percent of the fat formed of saturated fat. Treatment 2 used a first test nugget (test nugget 1) with 55 percent fat by weight, and about 85 percent of the fat derived from hydrogenated vegetable oil, resulting in the first test nugget containing about 47 percent saturated fat by weight of the nugget derived solely from hydrogenated vegetable oil. Treatment 3 used a second test nugget (test nugget 2) with 50 percent fat by weight of the nugget, in which the fat was derived from tallow and formed 40 percent by weight of the nugget, with about 43 percent by weight of the tallow being saturated fat, and hydrogenated vegetable oil formed 10 percent by weight of the nugget, with about 95 percent by weight of the hydrogenated vegetable oil being saturated fat, resulting in the second test nugget containing about 24 percent saturated fat by weight of the nugget primarily derived from tallow. Treatment 4 used a third test nugget (test nugget 3) with 50 percent fat by weight of the nugget in which the fat was derived from tallow and formed 24.5 percent by weight of the nugget, and hydrogenated vegetable oil formed 24.5 percent by weight of the nugget, with about 95 percent by weight of the hydrogenated vegetable oil being saturated fat, resulting in the second test nugget containing about 34 percent saturated fat by weight of the nugget primarily derived from the hydrogenated vegetable oil. The test nuggets included essentially the same protein and starch sources and levels as the control nugget. Testing involved offering 5 pounds of each treatment, and the pan locations were rotated daily. Losses were recorded.

Results:

TABLE 1
Study 1 Wild Bird Consumption of Control and Test
Nuggets Containing High Levels of Saturated Fats
Derived from Hydrogenated Vegetable Oil

| | Average | | |
|---|---|---|---|
| | Consumed, | Average | % of Control |
| Product | lbs./day | Consumed, % | Nugget Consumed |
| Control Nugget | 4.7 | 94.1 | 100.0 |
| Test Nugget 1 | 0.1 | 2.1 | 2.2 |
| Test Nugget 2 | 2.6 | 52.3 | 55.6 |
| Test Nugget 3 | 0.9 | 17.6 | 18.7 |

Summary of Results and Conclusions:

Wild birds readily consumed 100 percent of the control nugget. Test products in which the fat content contained least a portion of hydrogenated vegetable oil with highly saturated fatty acids resulted in wild birds reducing intake up to 97.8% for test nugget 1, 81.3% for test nugget 3, and 44.4% for test nugget 2. These results indicated that titrated levels of highly saturated fatty acids reduced consumption of test product by wild birds, but not as effectively as 100% replacement as in test nugget 1.

Study 2

Materials and Methods:

In this study titrated levels of hydrogenated vegetable oil with high levels of saturated fatty acids (e.g., 95 percent saturated fat by weight of the oil) were compared to the control nugget to determine if the birds have a proportional response to hydrogenated vegetable oil at lower levels, or if there is a threshold level at which the effect occurs. The study involved a side-by-side comparison over the course of 5 days with 4 treatments: the control nugget, test nugget 2 (38.9 percent tallow and 10 percent hydrogenated vegetable oil with 95 percent by weight of the hydrogenated vegetable oil being saturated fat), test nugget 3 (24.5 percent tallow and 24.5 percent hydrogenated vegetable oil with 95 percent by weight of the hydrogenated vegetable oil being saturated fat), and test nugget 4 (43.9 percent tallow and 5 percent hydrogenated vegetable oil with 95 percent by weight being saturated fat). Test nugget 4 included substantially the same protein and starch sources and levels as the control nugget. As in study 1, in this study 5 pounds of each treatment was offered and treatment locations were rotated daily. Losses were recorded.

Results:

TABLE 2
Study 2 of Wild Bird Consumption of Control and
Test Nuggets Containing High Levels of Saturated
Fats Derived from Hydrogenated Vegetable Oil

| | Average | | |
|---|---|---|---|
| | Consumed, | Average | % of Control |
| | lbs./day | Consumed, % | Nugget Consumed |
| Control Nugget | 3.4 | 68.7 | 100.0 |
| Test Nugget 2 | 1.0 | 19.6 | 28.5 |
| Test Nugget 3 | 0.0 | 0.3 | 0.4 |
| Test Nugget 4 | 1.3 | 26.3 | 38.3 |

Summary of Results and Conclusions:

Wild birds continued to consume the control nugget. Consumption of all test products was lower than that of the control nugget. The birds did consume small amounts of test product with the highest consumption being test nugget 4 containing the lowest amount of saturated fatty acids derived from hydrogenated vegetable oil. The lowest consumption was test nugget 3 containing the highest amount of saturated fatty acids derived from hydrogenated vegetable oil.

Study 3

Materials and Methods: To determine how bird consumption changes when all choices contain some level of hydrogenated vegetable oil, study 3 compared the test products to each other when no control product was offered. Test nuggets 2, 3 and 4 were offered side-by-side until two of the products were being completely consumed.

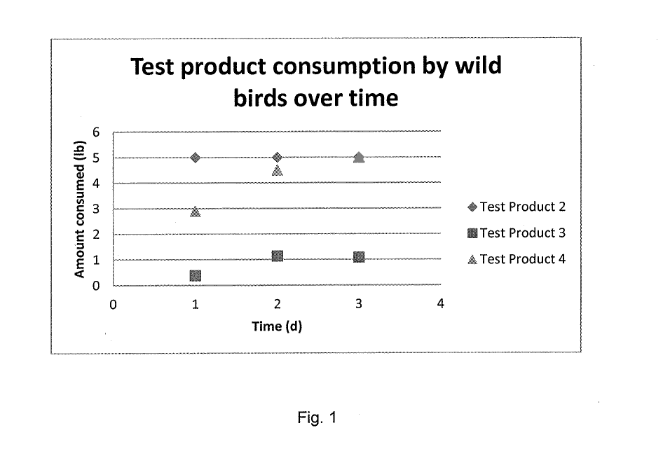

Results: The results of study 3 where test nuggets 2, 3 and 4 were offered for 3 days without the control nugget are illustrated in the graph of FIG. 1.

Summary of Results and Conclusions: In study 3, when the control nugget was not offered, wild birds increased their consumption of test products 2 and 4 so that they were consuming all that was offered within 3 days. The birds also increased their consumption of test product 3 to approximately 20 percent of what was offered. These results indicate that the fatty acid profile of test products 1 and 3 are not substantially different enough from the control nugget to prevent consumption when the control nugget is not offered as an alternative, but that 25 percent of the product being the highly saturated fatty acid profile in test product 2 may be effective.

Study 4

Materials and Methods:

To determine if birds would begin to consume test nugget 3 (25 percent hydrogenated vegetable oil by weight of the nugget) if no other choices were offered, two pans each containing 5 pounds of test nugget 3 were offered for 5 days. No other test or control nuggets were offered.

Results:

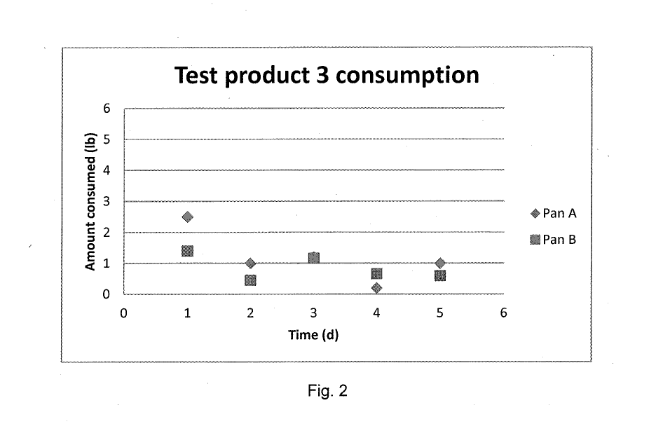

The results of study 4 where test nugget 3 was offered for 3 days without the other test or control nuggets are illustrated in the graph of FIG. 2.

Summary of Results and Conclusions:

In study 4, when test nugget 3 was the only option available, wild birds did not increase their consumption of test nugget 3. Overall consumption was 20 percent of the product offered, and this level of consumption was heavily driven by consumption on day 1, which appears to be an outlier.

When animal feed nuggets containing high levels of hydrogenated vegetable oil as the added fat, even if only an exterior fat coating, bird consumption is dramatically reduced even when no other options are available.

While the present disclosure provides various ranges, it will be understood that values, such as numeric integer values, at or within these ranges, or various ranges within the disclosed ranges, or ranges beginning or ending at a range value and beginning or ending at a value within the disclosed ranges may be used in particular embodiments without departing from the invention. For example, the percentage of saturated fat by weight of the total fat content within the animal feeds of the present disclosure may include any integer value from about 50 to about 100. In another example, the percentage of saturated fat by weight of the animal feed of the present disclosure may include any integer value from about 20 to about 55.

Although the present disclosure provides references to preferred embodiments, persons skilled in the art will recognize that changes may be made in form and detail without departing from the spirit and scope of the invention.

What is claimed is:

1. A method of deterring wild bird consumption of animal feed, the method comprising:
providing animals with a daily feed ration comprising an animal feed in a location accessible to wild birds,
wherein at least a portion of a nutrient profile of the animal feed is susceptible to wild bird consumption,
wherein the animal feed comprises a fat, said fat comprising hydrogenated vegetable oil, and
wherein the hydrogenated vegetable oil comprises saturated fatty acids, and the saturated fatty acids provided in an amount effective to reduce the wild bird consumption of the animal feed.

2. The method of claim 1, wherein at least a portion of the hydrogenated vegetable oil defines an exterior coating on the animal feed.

3. The method of claim 2, wherein a fat content of the animal feed is from about 20 to about 60 percent by weight of the animal feed.

4. The method of claim 3, wherein about 20 to about 100 percent by weight of the fat is hydrogenated vegetable oil.

5. The method of claim 4, wherein the hydrogenated vegetable oil contains at least about 80 percent by weight saturated fatty acids.

6. The method of claim 5, wherein stearic acid provides at least about 50 percent by weight of the saturated fatty acids.

7. The method of claim 1, wherein a fat content of the animal feed is from about 20 to about 60 percent by weight of the animal feed.

8. The method of claim 7, wherein about 20 to about 100 percent by weight of the fat is the hydrogenated vegetable oil.

9. The method of claim 8, wherein the hydrogenated vegetable oil contains at least about 80 percent by weight saturated fatty acids.

10. The method of claim 9, wherein stearic acid provides at least about 50 percent by weight of the saturated fatty acids.

11. The method of claim 1, wherein the wild bird consumption is reduced over the course of at least 5 days.

12. A method of forming a feed material adapted for deterring wild birds from consuming feed material otherwise susceptible to consumption by the wild birds, the method comprising:
forming a feed material comprising hydrogenated vegetable oil and at least one additional feed component susceptible to wild bird consumption, the hydrogenated vegetable oil in an amount effective to reduce consumption of said feed material.

13. The method of claim 12, wherein the step of forming the feed material further comprises coating the feed material with the hydrogenated vegetable oil.

14. The method of claim 13, wherein the hydrogenated vegetable oil forms at least about 20 percent of the feed material by weight and at least about 95 percent by weight of the hydrogenated vegetable oil is saturated fatty acids.

15. The method of claim 14, wherein the saturated fatty acids comprise one or more of lauric acid, myristic acid, palmitic acid or stearic acid.

16. The method of claim 14, wherein stearic acid provides at least about 50 percent by weight of the saturated fatty acids.

17. The method of claim 12, wherein the hydrogenated vegetable oil reduces wild bird consumption of said feed material by at least about 80 percent compared to wild bird consumption of a feed material that is the same as the feed material of claim 15 with the exception that the hydrogenated vegetable oil is replaced with fat from mixed plant and/or animal sources having lower levels of saturated fat.

18. An animal feed comprising hydrogenated vegetable oil, wherein the hydrogenated vegetable oil provides at least about 20 percent of the animal feed by weight, and wherein the hydrogenated vegetable oil contains at least about 95 percent by weight saturated fatty acids.

19. The animal feed of claim 18, wherein the saturated fatty acids comprise one or more of lauric acid, myristic acid, palmitic acid or stearic acid.

20. The animal feed of claim 18, wherein at least a portion of the hydrogenated vegetable oil defines an exterior coating over the animal feed.
